(19) United States
(12) Patent Application Publication
(10) Pub. No.: US 2021/0181892 A1
(43) Pub. Date: Jun. 17, 2021

(54) TOUCHLESS CONTROL GRAPHICAL USER INTERFACE

(71) Applicant: The Coca-Cola Company, Atlanta, GA (US)

(72) Inventor: Arthur G. RUDICK, Atlanta, GA (US)

(21) Appl. No.: 16/079,687

(22) PCT Filed: Feb. 16, 2017
(86) PCT No.: PCT/US2017/018190

§ 371 Date: Aug. 24, 2018

Related U.S. Application Data
(60) Provisional application No. 62/300,298, filed on Feb. 26, 2016.

(51) Int. Cl. G06F 3/042; G06F 3/041

(52) U.S. Cl. CPC G06F 3/0425; G06F 2203/04101; G06F 3/0412

(57) ABSTRACT

A dispensing device can include: a display screen configured to present a plurality of selectable options for controlling dispensing of a plurality of products, the display screen showing a graphical user interface that displays the plurality of selectable options in three dimensions; a touchless input control system configured to receive selection from a consumer of one selectable option from the plurality of selectable options; and a dispensing system for dispensing a beverage associated with the one selectable option.

This application is being filed on Feb. 16, 2017, as a PCT International Patent application and claims priority to U.S. Provisional patent application Ser. No. 62/300,298, filed Feb. 26, 2016, the entire disclosure of which is incorporated by reference in its entirety.

### RELATED APPLICATION(S)

This patent application is related (but does not claim the benefit of priority) to U.S. Patent Application Ser. No. 62/183,860 filed on Jun. 24, 2015, the entirety of to which is hereby incorporated by reference.

### BACKGROUND

Modern devices like dispensing devices include functionality for consumers to select from a menu of available products and to access device functions on a display screen. Typically, the consumer is presented with a list of products (e.g., beverages) for purchase or dispense via the display screen. The consumer then interacts with controls associated with that display screen to select one or more of those products for dispense.

### SUMMARY

This summary is provided to introduce a selection of concepts in a simplified form that are further described below. This summary is not intended to identify key features or essential features of the claimed subject matter, nor is it intended as an aid in determining the scope of the claimed subject matter.

In one aspect, a dispensing device includes: a display screen configured to present a plurality of selectable options for controlling dispensing of a plurality of products, the display screen showing a graphical user interface that displays the plurality of selectable options in three dimensions; a touchless input control system configured to receive selection from a consumer of one selectable option from the plurality of selectable options; and a dispensing system for dispensing a beverage associated with the one selectable option.

In another aspect, a dispensing device including a touchless control system has: a display screen configured to present a plurality of selectable options for controlling dispensing of a plurality of products, the display screen showing a three-dimensional graphical user interface that displays the plurality of selectable options in three dimensions to a consumer without special three-dimensional glasses; a touchless input control system configured to receive selection from the consumer of one selectable option of the plurality of selectable options, wherein the touchless input control system includes a touch screen configured to operate in a hypersensitive mode that causes the touch screen to sense a fingertip of the consumer at a distance from the touch screen, wherein the distance is selected to approximate a three-dimensional position of one or more of the plurality of selectable options; and a dispensing system to for dispensing a beverage associated with the one selectable option.

In yet another aspect, a method of controlling a beverage dispensing system includes: displaying, upon a display screen in three dimensions, a plurality of selectable options for controlling dispensing of plurality of beverages; allowing a consumer to select one selectable option of the plurality of selectable options without touching the display screen; and dispensing a beverage associated with the one selectable option.

### BRIEF DESCRIPTION OF THE DRAWINGS

FIG. 1 is a schematic depiction of a system for providing a dispenser control graphical user interface on a dispensing device.

FIG. 2 is an example three dimensional graphical user interface for a display screen of the dispensing device of FIG. 1.

FIG. 3 is a side view of the display screen of the dispensing device of FIG. 1 with the three dimensional graphical user interface of FIG. 2 shown thereon.

FIG. 4 is another side view of the three dimensional graphical user interface of FIG. 3.

FIG. 5 is another side view of the display screen of the dispensing device of FIG. 1 with another example three dimensional graphical interface shown thereon.

FIG. 6 is another side view of the three dimensional graphical interface of FIG. 5.

FIG. 7 is another side view of the three dimensional graphical interface of FIG. 5.

FIG. 8 is another side view of the three dimensional graphical interface of FIG. 5.

FIG. 9 is another example three dimensional graphical user interface for the dispensing device of FIG. 1.

FIG. 10 is a side view of the display screen of the dispensing device of FIG. 1 with the three dimensional graphical user interface of FIG. 9 shown thereon.

FIG. 11 is another side view of the three dimensional graphical user interface of FIG. 9.

FIG. 12 is another side view of the three dimensional graphical user interface of FIG. 9.

FIG. 13 is another example three dimensional graphical user interface for to the dispensing device of FIG. 1.

FIG. 14 is a side view of the display screen of the dispensing device and the three dimensional graphical user interface of FIG. 13 shown thereon.

FIG. 15 is a side view of the display screen of the dispensing device and the three dimensional graphical user interface of FIG. 13 shown thereon.

FIG. 16 is another example three dimensional graphical user interface for the dispensing device of FIG. 1.

FIG. 17 is another view of the graphical user interface of FIG. 16.

FIG. 18 is another view of the graphical user interface of FIG. 16.

FIG. 19 is another view of the graphical user interface of FIG. 16.

FIG. 20 is another view of the graphical user interface of FIG. 16.

FIG. 21 is another view of the graphical user interface of FIG. 16.

FIG. 22 is an example calibration graphical user interface for the dispensing device of FIG. 1.

FIG. 23 is a side view of the calibration graphical user interface of FIG. 22.

FIG. 24 is a schematic view of a consumer's eye.

FIG. 25 is another schematic view of the consumer's eye of FIG. 24.

FIG. 26 is another schematic view of the consumer's eye of FIG. 24.

FIG. 27 is another example calibration graphical user interface for the dispensing device of FIG. 1.

FIG. 28 is a side view of the calibration graphical user interface of FIG. 27.

FIG. 29 is another side view of the calibration graphical user interface of FIG. 27.

FIG. 30 is a schematic depiction of the dispensing device of FIG. 1.

### DETAILED DESCRIPTION

Embodiments are provided for controlling the operation of a device, such as a dispensing device, utilizing a control interface. The control interface can include a display screen for presenting options that are utilized for controlling various selectable options associated with the dispensing device. For example, the selectable options can be selections of various beverages for dispensing by the dispensing device, although other configurations are possible.

In the following detailed description, references are made to the accompanying drawings that form a part hereof, and in which are shown by way of illustrations specific embodiments or examples. These embodiments may be combined, other embodiments may be utilized, and structural changes may be made. The following detailed description is therefore not to be taken in a limiting sense, and the scope of the embodiments described herein is defined by the appended claims and their equivalents.

The term “beverage,” as used herein, may include, but is not limited to, pulp and pulp-free citrus and non-citrus fruit juices, fruit drink, vegetable juice, vegetable drink, milk, soy milk, protein drink, soy-enhanced drink, tea, water, isotonic drink, vitamin-enhanced water, soft drink, flavored water, energy drink, coffee, smoothies, yogurt drinks, hot chocolate and combinations thereof. The beverage may also be carbonated or non-carbonated. The beverage may comprise beverage components (e.g., beverage bases, colorants, flavorants, and additives) that are combined in various contexts to form the beverage.

The term “beverage base” may refer to parts of the beverage or the beverage itself prior to additional colorants, additional flavorants, and/or additional additives. According to some embodiments, beverage bases may include, but are not limited to syrups, concentrates, and the like that may be mixed with a diluent such as still or carbonated water or other diluent to form a beverage.

The term “beverage base component” may refer to components that may be included in beverage bases. According to some embodiments, the beverage base components may be micro-ingredients such as an acid portion of a beverage base; an acid-degradable and/or non-acid portion of a beverage base; natural and artificial flavors; flavor additives; natural and artificial colors; nutritive or non-nutritive natural or artificial sweeteners; additives for controlling tartness, e.g., citric acid, potassium citrate; functional additives such as vitamins, minerals, or herbal extracts; nutraceuticals; or medicaments.

Thus, for the purposes of requesting, selecting, or dispensing a beverage base, a beverage base formed from separately stored beverage base components may be equivalent to a separately stored beverage base. For the purposes of requesting, selecting or dispensing a beverage, a beverage formed from separately stored beverage components may be equivalent to a separately stored beverage.

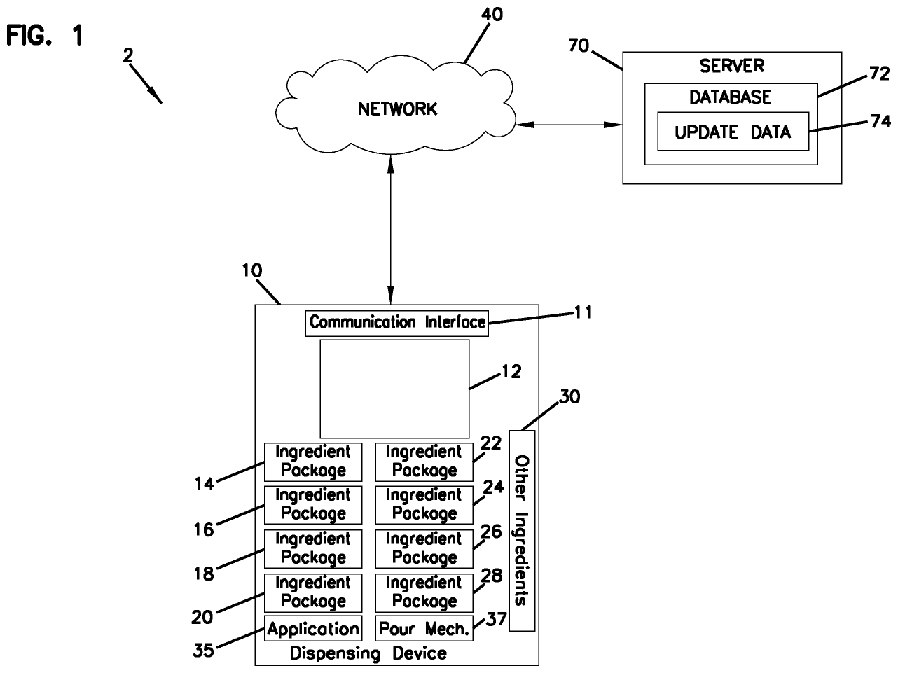

Referring now to the drawings, in which like numerals represent like elements through the several figures, various aspects will be described. FIG. 1 is a schematic diagram illustrating an example system 2 for providing a dispenser control graphical user interface on a dispensing device 10. The dispensing device 10 may include a communication interface 11 and a control interface that may comprise a selectable display screen 12.

The dispensing device 10 may also include ingredient packages (or pouches) 14, 16, 18, 20, 22, 24, 26 and 28. In some embodiments, the ingredient packages 14, 16, 18 and 20 may comprise various beverage bases or beverage base components such as beverage bases. In some embodiments, the ingredient packages 22, 24, 26, and 28 may comprise flavors (i.e., flavoring agents, flavor concentrates, or flavor syrups). In some embodiments, the beverage bases in the ingredient packages 14, 16, 18, and 20 may be concentrated syrups. In some embodiments, the beverage bases in the ingredient packages 14, 16, 18 and 20 may be replaced with or additionally provided with beverage base components. In some embodiments, each of the beverage bases or beverage base components in the ingredient packages and each of the flavors in the ingredient packages 22, 24, 26 and 28 may be separately stored or otherwise contained in individual removable cartridges that are stored in the dispensing device 10.

The aforementioned beverage components (i.e., beverage bases or beverage base components and flavors) may be combined, along with other beverage ingredients 30, to dispense various beverages or blended beverages (i.e., finished beverage products) from the dispensing device 10. The other beverage ingredients 30 may include diluents such as still, sparkling, or carbonated water, functional additives, or medicaments, for example. The other beverage ingredients 30 may be installed in the dispensing device 10, pumped to the dispensing device 10, or both.

The dispensing device 10 may also include a pour mechanism 37 for dispensing various beverages or blended beverages. The dispensing device 10 may further include a separate reservoir (not shown) for receiving ice and water for use in dispensing beverages. The dispensing device 10 may further include other types of product dispensers in accordance with some embodiments.

The dispensing device 10 may also be in communication with a server 70 over a network 40 that may include a local network or a wide area network (e.g., the Internet). In some embodiments, the communication between the dispensing device 10 and the server 70 may be accomplished utilizing any number of communication techniques including, but not limited to, BLUETOOTH wireless technology, Wi-Fi and other wireless or wireline communication standards or technologies, via the communication interface 11. The server 70 may include a database 72 that may store update data 74 associated with the dispensing device 10. In some embodiments, the update data 74 may comprise a software update for the application 35 on the dispensing device 10.

In some embodiments, the selectable display screen 12 may be actuated for selecting options associated with operating the dispensing device 10. The selected operations may include, but are not limited to, individually selecting and/or dispensing one or more products (e.g., beverage products), dispensing device initialization, product change out, product replacement and accessing a utilities menu (e.g., for dispensing device calibration, setting a clock/calendar, connecting to Wi-Fi, retrieving software updates, etc.).

In this example, the display screen 12 is a three-dimensional display device. A three-dimensional display device can be operated in a three-dimensional mode and/or a two-dimensional mode. In the two-dimensional mode, the display screen 12 may be substantially similar in appearance to a conventional flat screen TV or computer monitor.

When in the three-dimensional mode, the display screen 12 provides enhanced consumer engagement opportunities by placing visual entities at different apparent distances to the consumer. In other words, a three dimensional view is provided by a graphical user interface 120 of the display screen 12, so that items depicted on the graphical user interface 120 appear to be positioned in three-dimensional space located in front of and/or behind the display screen 12 when the consumer views the graphical user interface 120.

For the purpose of this disclosure, the display screen 12 may or may not require the consumer to wear special three-dimensional glasses in order to view the three dimensional effect. In one example, a lenticular display, such as that provided by the display of a Nintendo 3DS from Nintendo of America Inc., can be used. Another example includes the lenticular three dimensional displays from Marvel Digital Limited. Such display devices provide the effects of a three-dimensional display to the consumer without requiring the consumer to wear special three-dimensional glasses. In another example, a KDL50W800B television from Sony Corporation provides the three-dimensional effect but requires the consumer to wear glasses to see the three-dimensional effect.

In this embodiment, the display screen 12 is an autostereoscopic three-dimensional display that provides the illusion of three dimensions to the consumer without requiring the consumer to wear glasses. Examples of this display technology include lenticular lens displays, parallax barrier displays, volumetric displays, holographic displays and light field displays. Other configurations are possible.

In example embodiments described below, the dispensing device 10 is configured so that the consumer can interact with the dispensing device 10 without physically touching the display screen 12. In other words, the dispensing device 10 is configured so that the consumer can interact with the display screen 12 using various “touchless” systems and methods, such as by the consumer providing gestures and/or eye movements that are tracked by the dispensing device 10. These systems and methods of touchless interaction are described further below.

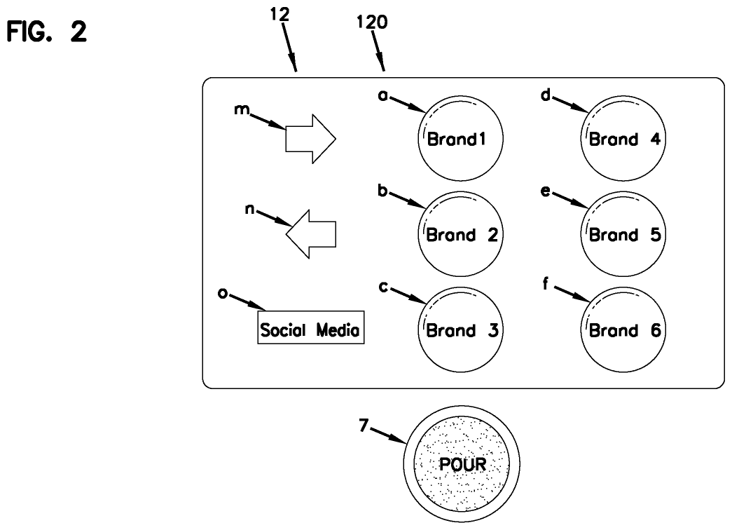

Referring now to FIGS. 2-4, the example display screen 12 of the dispensing device 10 is shown in more detail. An example graphical user interface 120 is shown on the display screen 12.

Visual entities are displayed on the graphical user interface 120. These visual entities are selectable items that include, but are not limited to, brand category icons a-f, navigational tools m and n, and command buttons, such as a “connect to social media” icon o. A push-to-pour button 7 is also provided on the graphical user interface 120.

In this example, the display screen 12 displays the graphical user interface 120 in three dimensions. In this manner, the visual entities appear in three dimensions in front (or behind, in some embodiments) of the display screen 12. This is accomplished using one or more of the techniques described above, such as by an autostereoscopic three-dimensional display.

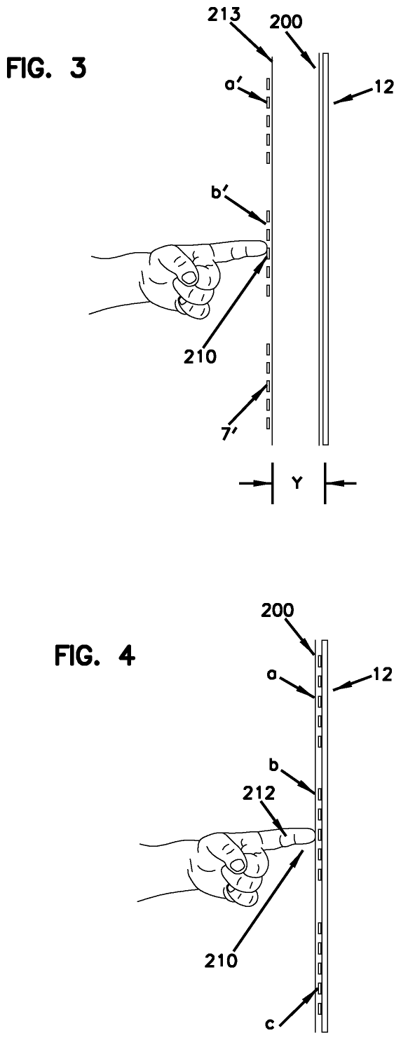

Referring now to FIGS. 3-4, the display screen 12 also includes a touch screen 200. In this example, the touch screen 200 is a capacitive touch screen, although other technologies can be used.

Typically, the sensitivity of a touch screen is tuned so that a touch is registered approximately when a consumer's fingertip 210 touches the surface of the screen. However, in this instance, the touch screen 200 is configured with its sensitivity tuned to extend the sensing range, so that the consumer can select visual entities by touching the apparent positions of the visual entities in three dimensional space in front of the display screen 12, thus maintaining the illusion of three dimensionality and providing a sanitary touch-free graphical user interface.

Specifically, the sensitivity of the touch screen 200 is tuned to be in a “hypersensitive mode”. In the hypersensitive mode, the sensing range of the touch screen 200 can be extended so that a touch is registered some distance before the consumer's finger 212 touches the surface of the touch screen 200. By tuning the distance from the touch screen 200 at which the touch screen registers a touch to be approximately equal to the apparent distance of a visual entity (a-o) from the touch screen 200, the consumer may experience the illusion of touching a visual entity floating in three-dimensional space. The hypersensitive mode can be accomplished by increasing sensing thresholds and sampling of the touch screen. Modification of the size and shape of the capacitive sensor of the touch screen can also be done to accomplish the desired tuning.

In the examples describe herein, the touch screen 200 operates in a normal mode when the touch screen 200 registers or otherwise senses the presence of the consumer's fingertip as the fingertip is substantially near and/or touching the touch screen 200. In contrast, the touch screen 200 operates in the hypersensitive mode when the touch screen 200 registers or otherwise senses the presence of the fingertip at a distance from the touch screen 200 (i.e., increasing the sensing distance), such as at 0.5, 1.0, 1.5, and/or 2.0 inches from the touch screen 200. The distances can vary.

For example, as shown in FIG. 3, in the hypersensitive mode of operation, the touch screen 200 is located in association with the display screen 12 and is substantially the same size as the display screen 12. In this example, the touch screen 200 is located in very close proximity to the display screen 12 so as to be substantially co-planar.

The display screen 12 is configured so that the visual location of the selectable visual entities a, b, and c lies on a plane 213 positioned in front of the display screen 12. Specifically, selectable visual entities a′, b′, and c′ lie on the plane 213, which is parallel to the display screen 12 but offset a distance y from the display screen 12.

The sensitivity of the touch screen 200 is adjusted to be hypersensitive so that the consumer's fingertip 210 registers a touch at approximately the same distance y from the touch screen 200. In the example shown in FIG. 2, the consumer may experience the illusion of selecting the visual entity a on the display screen 12 by touching the visual entity a′ floating in space in front of the touch screen 200 the distance y.

Various indications can be provided to the consumer to assist the consumer when interacting with the dispensing device 10 in this manner. For example, when the consumer places the consumer's fingertip 210 at the distance y to select the visual entity b′ (associated with “Brand 2”), the display screen 12 can be programmed to visually highlight (as described further below) the visual entity b′ so that the consumer readily knows that the visual entity b′ is selected. If the consumer maintains the selection for a period of time (e.g., 0.5, 1, 2, 3, or 5 seconds), the visual entity b′ may be retained in a selected state.

Once the selection is made, the consumer can thereupon select the hand operated push-to-pour button 7, which may be located on the front of the dispenser and may be aligned with the distance y to cause the dispensing device 10 to dispense the selected brand.

In this manner, the consumer can interact with the visual entities shown in three dimensions in a visually-intuitive manner. Further, the consumer interacts with the dispensing device 10, e.g., by selecting one or more beverages for dispense and dispensing them (e.g., by selecting the push-to-pour button 7 entity after selecting brands a-f) without having to physically touch the touch screen 200.

Although the example display screen 12 is described as a three dimensional display screen, in other examples, the touch screen 200 can be used in conjunction with a two dimensional display screen. In those embodiments, the visual entities are displayed on the display screen in a conventional two dimensional manner. The consumer could then select the visual entities by bringing the consumer's fingertip (or other body part) close to, but not necessarily touching, the touch screen. Other configurations are possible.

Referring now to FIG. 4, in some examples, the touch screen 200 provides a second mode of operation, so that the display screen 12 functions in two dimensions and the touch screen performs in a “normal” mode so that selections are made only when the touch screen 200 is physically touched.

In this normal mode, the visual entities (a), (b), and (c) are displayed in two dimensions on the surface of the display screen 12, and the touch screen 200 is tuned to register touches by the fingertip 210 at the surface of the touch screen (as would be expected in a conventional touch screen). In this normal mode of use, the dispensing device 10 operates with the “conventional” touch screen 200 so that for example, a service technician can manipulate the dispensing device 10 more readily. The dispensing device 10 may be switched between the hypersensitive and normal modes of operation as needed.

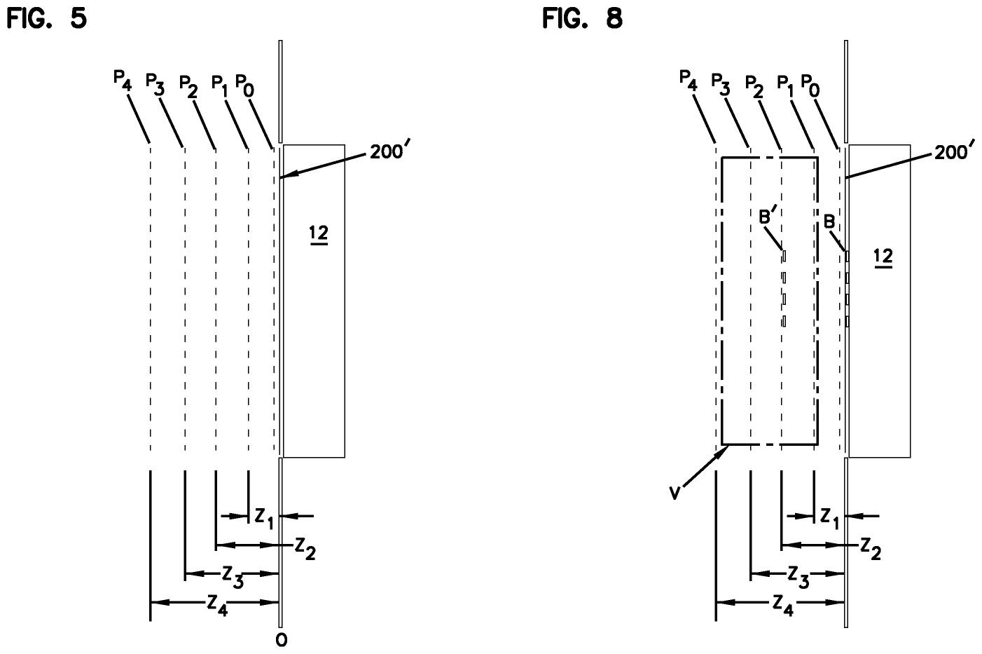

Referring now to FIGS. 5-8, another embodiment of the dispensing device 10 including a touch screen 200′ is shown. In this example, the touch screen 200′ performs in a manner similar to the touch screen 200 described above, in that the touch screen 200′ is set so as to be hypersensitive so a touch can be registered at some distance in front of the display screen 12. However, for the touch screen 200′, the hypersensitivity is varied in time so that the actual distance of the fingertip 210 from the touch screen 200′ can be estimated, as described below.

When the touch screen 200′ is set so as not to be hypersensitive (Z0), an interaction plane P0 is substantially co-planar with the front of the touch screen 200′. When the touch screen 200′ is set at a maximum level of hypersensitivity, an interaction plane P4 may be at some maximum distance Z4 in front of the touch screen.

In this example, the touch screen 200′ also has intermediate levels of hypersensitivity that result in interaction planes, such as P1, P2, and P3, located at varying distances Z1, Z2, and Z3 from the front surface of the touch screen 200′, respectively. Different levels of hypersensitivity can be calibrated to known distances (Z1, Z2, Z3) from the front of the touch screen 200′. In this example, three intermediate levels of hypersensitivity are shown, but any number of interim levels of hypersensitivity can be set.

As the level of sensitivity cycles from non-hypersensitive (Z0), through the various intermediate levels to the maximum level of hypersensitivity, then the position of the interaction plane will cycle through positions (P0, P1, P2, P3, and P4) at corresponding known distances from the screen (0, Z1, Z2, Z3, and Z4). This cyclically changing location of the interaction plane (P) effectively cyclically sweeps the volume of space in front of the touch screen 200′. In such an example, the dispensing device 10 is programmed to perform a sweep cycle that allows the hypersensitivity to cycle between the various levels in a periodic fashion (e.g., once every 1 millisecond to 1 second).

Referring to FIG. 6, an object (for example the consumer's fingertip 210) approaches at the distance Z4 from the touch screen 200′. A sweep cycle proceeds as follows:
at a non-hypersensitive setting, interaction plane P0 will not detect the fingertip 210;
at a first interim hypersensitive setting, interaction plane P1 will not detect the fingertip 210;
at a second interim hypersensitive setting, interaction plane P2 will not detect the fingertip 210;
at a third interim hypersensitive setting, interaction plane P3 will not detect the fingertip 210; and
at the maximum hypersensitive setting, interaction plane P4 will detect the fingertip 210.
   Because the location Z4 of the interaction plane P4 is generally known, the distance Z4 between the fingertip 210 and the front of the touch screen 200′ is known by the dispensing device 10.

As shown in FIG. 7, as the consumer continues to move the consumer's fingertip 210 closer, the sweep cycle will proceed as follows:
at a non-hypersensitive setting, interaction plane (P0) will not detect the fingertip 210;
at a first interim hypersensitive setting, interaction plane (P1) will not detect the fingertip 210; and
at a second interim hypersensitive setting, interaction plane (P2) will detect the fingertip 210. Because the location Z2 of the interaction plane P2 is known, the distance Z2 between the fingertip 210 and the front of the touch screen 200′ is known.

If the sweep cycle is repeated rapidly enough, then an object, such as the fingertip 210, moving towards the touch screen 200′ can be tracked dynamically in three dimensions. The location of the fingertip 210 can be updated with each cycle, as shown between FIGS. 6 and 7. The X and Y coordinates of the user's fingertip 210 can also be determined through conventional touch screen technology.

In some examples, the distance Z1-Z4 can be used to assist the consumer when interacting with the dispensing device 10 in this manner. For example, when the consumer places the consumer's fingertip 210 at the distance Z4 at a position to select a visual entity displayed by the display screen 12, the display screen 12 can be programmed to visually highlight the visual entity so that the consumer readily knows that the visual entity is selected. If the consumer continues to move the fingertip 210 closer, such as to a distance Z2, the visual entity may be retained in a selected mode by the dispensing device 10.

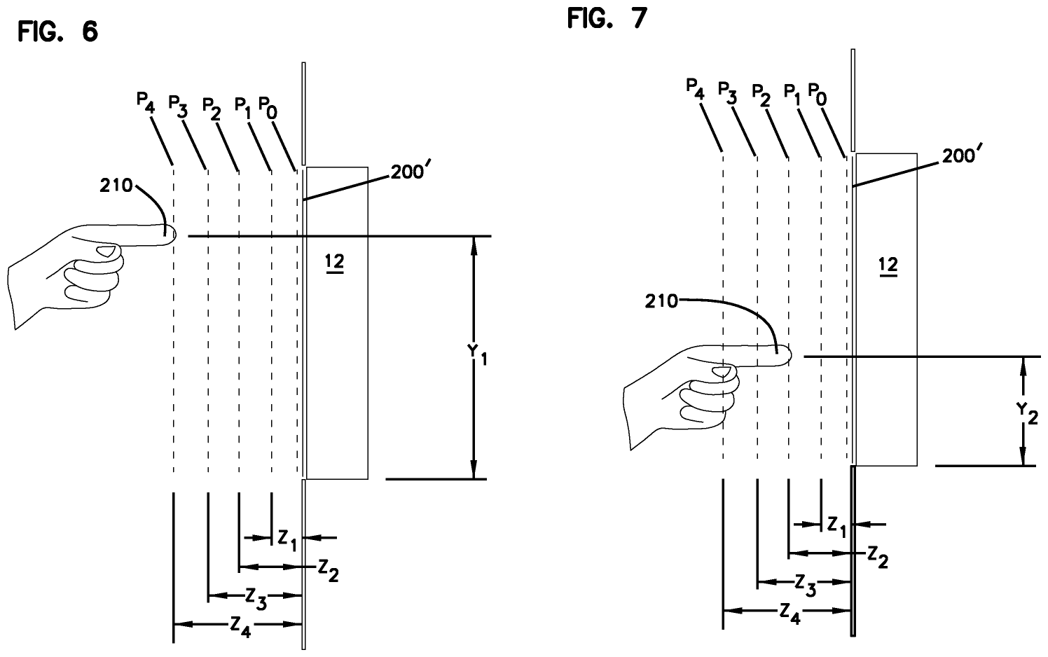

Referring now to FIG. 8, in another example, an interactive volume V may be defined as a subset of the swept areas P0-P4. The volume V is similar to the interaction volume 311 described below, in that various aspects of the consumer's experience can be manipulated as the consumer's fingertip moves within the volume V. In some embodiments, this includes a first feedback that results in an indication of (e.g., highlighting) a particular selectable option at a first distance from the display screen and a second feedback of an actual selection of that selectable item at a second closer distance.

For example, as the consumer's finger enters the volume V (e.g., by moving the fingertip at least a distance Z4 from the touch screen 200′), the display screen 12 can be modified to provide a ripple effect to provide visual (or audio, in some instances) que of the fingertip placement relative to the display device 12. By further moving the fingertip to the entity b′ within the volume V, the display screen 12 can further be modified to indicate a selection of the entity b, as described herein. Other configurations are possible.

Although the example display screen 12 is described as a three dimensional display screen, in other examples, the touch screen 200′ can be used in conjunction with a two dimensional display screen. In those embodiments, the visual entities are displayed on the display screen in a conventional two dimensional manner. The consumer could then select the visual entities by bringing the consumer's fingertip (or other body part) close to, but not necessarily touching, the touch screen. As described, the touch screen can be configured to identify a distance of the fingertip from the two dimensional screen so that various effects (such as the ripple and/or highlighting) can be accomplished in two dimensions on the display screen. Other configurations are possible.

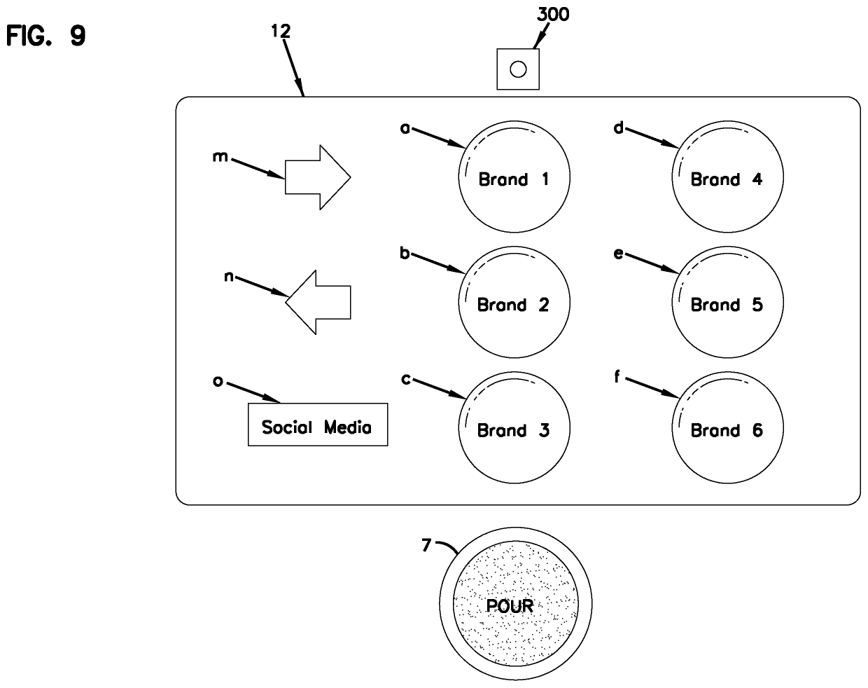

Referring now to FIGS. 9-15, another embodiment including the display screen 12 is shown. In this example, a gesture tracking system 300 is used in place of (or in conjunction with) the touch screen to determine and allow for touchless consumer interaction with the dispensing device 10.

In one example, the gesture tracking system 300 is a motion sensing input device, such as the Kinect device manufactured by Microsoft Corporation. In such an embodiment, the gesture tracking system 300 includes an infrared projector and camera that are used to track the movement of objects (e.g., hands/fingertips, etc.) in three dimensions. Other similar technologies can be used.

Similar to the hypersensitive touch screens 200, 200′ described above, the gesture tracking system 300 provides enhanced consumer engagement by allowing the consumer to intuitively select visual entities by touching the apparent positions of the visual entities in three dimensional space, thus fully maintaining the illusion of three dimensionality and providing a sanitary touch-free graphical user interface.

Referring to FIG. 9, the gesture tracking system 300 is located in association with the front of the display screen 12. As before, the display screen 12 includes a graphical user interface with visual entities displayed therein in three dimensions.

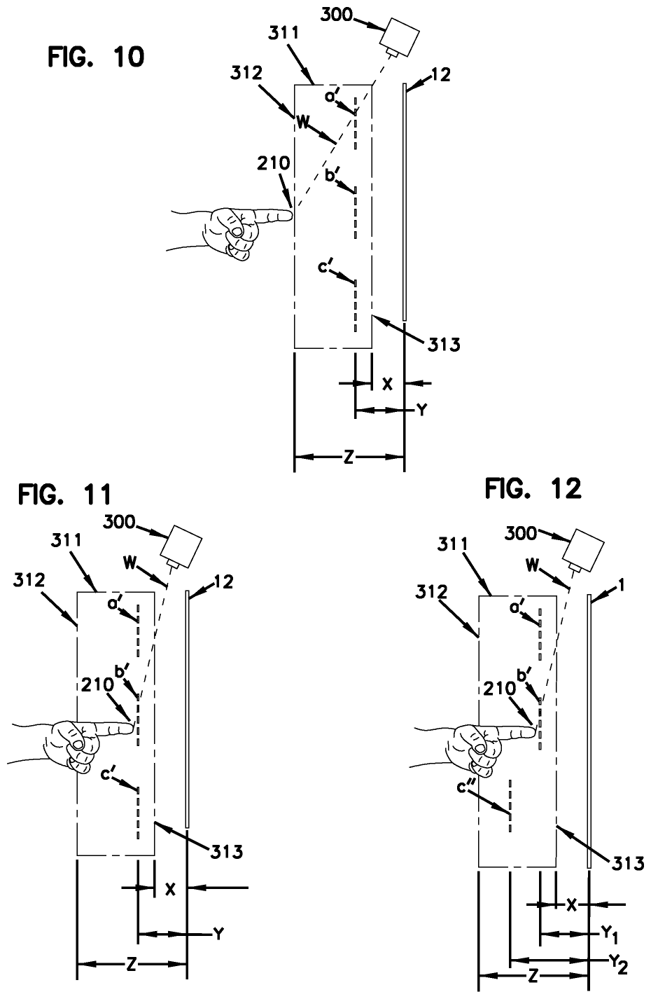

Referring now to FIGS. 10-12, in this example, a three-dimensional interaction volume 311 is formed by the gesture tracking system 300 located in front of the display screen 12. A front surface 312 of the interaction volume 311 may be located at some distance Z from the front of the display screen 12. For example, the distance Z may be 6 to 12 inches. A back surface 313 of the interaction volume 311 may be located at some distance X from the display screen 12, where the back surface 313 of the interaction volume 311 may be in close proximity to the front of the display screen 12. For example the distance X may be 0 to 3 inches. Other dimensions are possible. The top, bottom, and sides of the interaction volume 311 may approximately correspond to the top, bottom, and side edges of the graphical user interface on the display screen 12.

The fingertip 210 of the consumer can be used to select visual entities on the display screen 12. As before, the selectable visual entities include brand category icons (a), (b), and (c) having corresponding apparent visual locations (a′), (b′), and (c′) positioned at some distance Y in front of the display screen 12, where (Y)>(X) so that the apparent visual locations of the selectable visual entities are within the interaction volume 311. Selectable visual entities may be located at multiple distances from the display screen 12, such as distances Y1 and Y2, as shown in FIG. 12.

A virtual line W between the gesture tracking system 300 and the fingertip 210 of the consumer represents a straight line in three-dimensional space. This line W is calculated by the gesture tracking system 300 and is used to determine the location of the fingertip 210 in three-dimensional space.

In use, the various positions within the interaction volume 311 can be used to provide feedback to the consumer. For example, referring to FIG. 10, when the consumer's fingertip 210 crosses the front surface 312 of the interaction volume 311, the dispensing device 10 can provide a first indication (visual, audio, etc.) highlighting the location of the consumer's fingertip 210 within the interaction volume 311. When the consumer's fingertip 210 leaves the interaction volume 311, the first indication can disappear.

When the consumer's fingertip 210 comes close to the apparent visual position, e.g., b′ of a selectable visual entity b in FIGS. 11-12, the dispensing device 10 can provide a second indication (visual, audio, etc.) signaling that selection of the selectable visual entity b is imminent. When the consumer's fingertip 210 moves away from the apparent visual position, e.g., b′ of the selectable visual entity b, the second indication can disappear.

The gesture tracking system 300 may use the consumer's gestures to manipulate or navigate among the visual entities. For example, the consumer may sweep the consumer's hand through the interaction volume 311 from left to right to navigate to the next display in a sequence of displays. The consumer may also, for example, sweep the hand through the interaction volume 311 from right to left to navigate to the previous display in a sequence of displays. In another example, the consumer may insert both hands into the interaction volume 311 then move them together in a pinching motion to zoom out. The consumer may also insert both hands into the interaction volume 311 then move them apart to zoom in. Other configurations are possible.

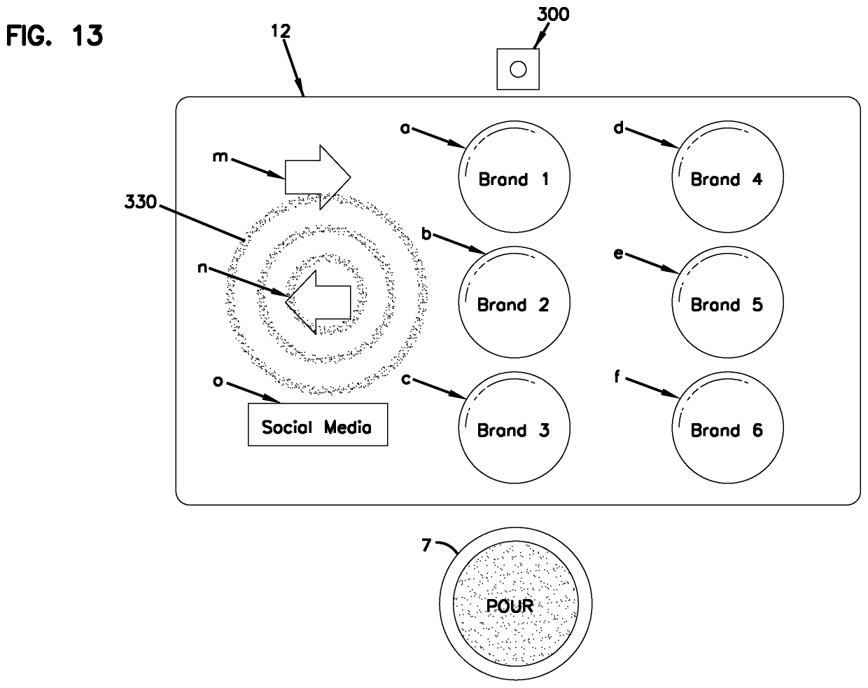

FIG. 13 shows an example of a first indication highlighting of a position of the consumer's fingertip 210 within the interaction volume 311. In this example, when the consumer's fingertip 210 enters the interaction volume (as shown in FIG. 10) in alignment with the selectable visual entity n, the front surface 312 of the interaction volume 311 appears to shimmer like ripples 330 on water when a finger is put into water. The center of the ripples may follow the consumer's fingertip 210 as it moves up/down/left/right along the front surface 312 of the interaction volume 311. Examples of the second indication signaling that a selection is imminent include a change in the visual brightness, color, or size of a selectable visual entity, or the selectable visual entity may flash.

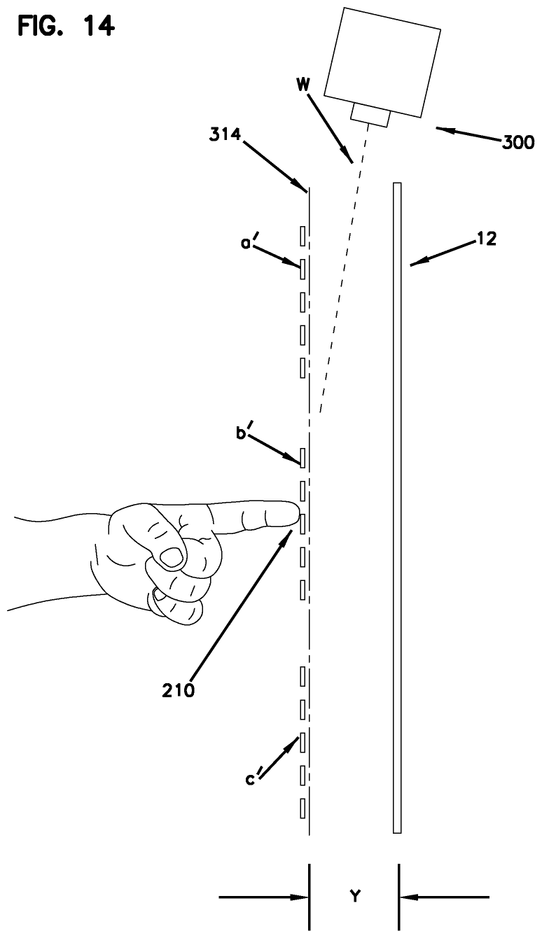

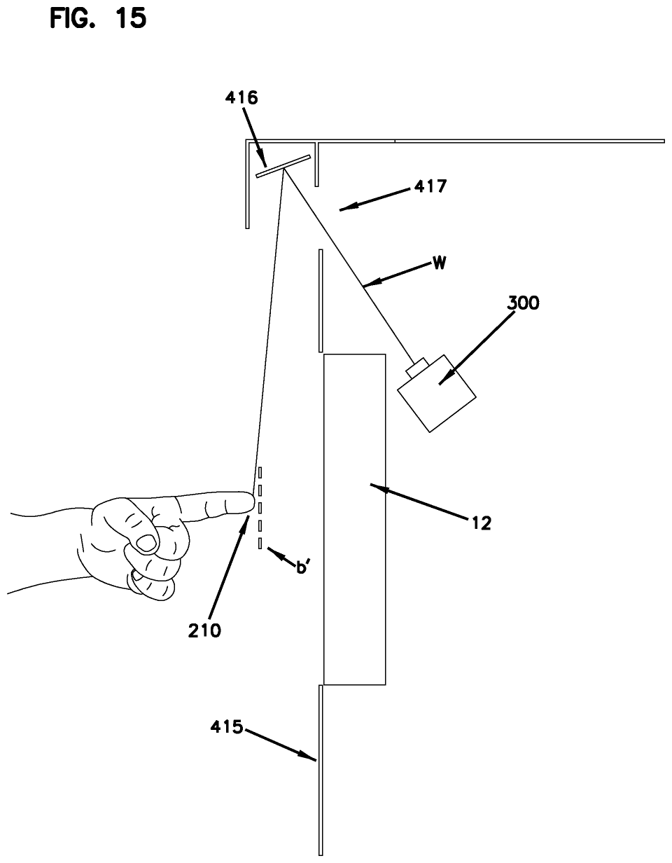

Referring to FIG. 14, a simplified embodiment of the gesture tracking system 300 includes a single interactive plane 314 (rather than the interaction volume 311) at some distance Y from the front of the display screen 12. The edges of the interactive plane 314 may substantially coincide with the edges of the display screen 12. The apparent visual locations, e.g., a′, b′, or c′ of the visual entities a, b, or c are substantially co-planar with the interactive plane 314. When the consumer's fingertip 210 coincides with the interactive plane 314 and the apparent visual location, e.g., b′ of the selectable visual entity b, that selectable visual entity may be selected.

Although the example display screen 12 is described as a three dimensional display screen, in other examples, the gesture tracking system 300 can be used in conjunction with a two dimensional display screen. In those embodiments, the visual entities are displayed on the display screen in a conventional two dimensional manner. The consumer could then manipulate and/or select the visual entities by performing one or more gestures. Other configurations are possible.

In FIGS. 9-14, the gesture tracking system 300 is shown as being located substantially incident (e.g., above and adjacent to/in front of) with the display screen 12. Referring to FIG. 15, in an alternative embodiment, the gesture tracking system 300 is located behind the display screen 12.

For example, the gesture tracking system 300 can be located within a housing 415 of the dispensing device 10. An appropriately positioned mirror 416 may allow the gesture tracking system 300 to “see” the consumer's fingertip 210 in front of the display screen 12 and thereby construct the line W from the gesture tracking system 300 to the consumer's fingertip 210 via the mirror 416. The line W is used to determine the location of the consumer's fingertip 210 in three-dimensional space, as above. The line W can travel through an opening 417 in the housing 415 of the dispensing device 10. The opening (417) in the housing 415 may comprise a transparent panel (not shown). This alternative location may apply to both the first and second embodiments of this invention.

There are various possible advantages associated with locating the gesture tracking system 300 within the housing 415. For example, the housing 415 can provide protection for the gesture tracking system 300. Further, locating the gesture tracking to system 300 within the housing 415 allows the gesture tracking system 300 to be located further from the consumer, which can result in a greater field of vision for the gesture tracking system 300. Additional mirrors can be positioned inside or outside of the housing 415 to further increase this field of vision.

FIGS. 9-15 schematically show tracking of the fingertip 210 by the gesture tracking system 300 along the vertical axis. The gesture tracking system 300 tracks input along the horizontal axis in a similar manner.

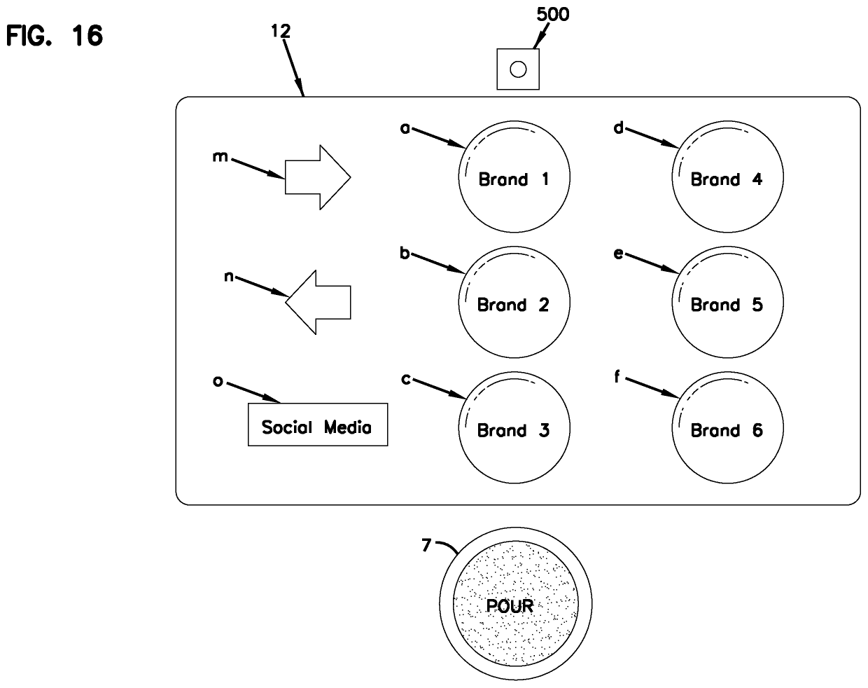

Referring now to FIGS. 16-21, the dispensing device 10 includes the display screen 12 and an eye tracking system 500. In this example, the eye tracking system 500 is configured to track one or both of the eyes of the consumer as the consumer views and interacts with the display screen 12 in a touchless fashion. In these examples, the display screen 12 can be provided in two dimensions and/or in three dimensions.

In this example, the eye tracking system 500 is combination of one or more infrared projectors that create reflection pattern(s) of infrared light on the eyes and one or more sensors that capture those infrared patterns to estimate eye position and gaze point, such as eye tracking systems provided by Tobii AB. Other eye tracking technologies can be used.

In this embodiment, the consumer selects visual entities by looking at their apparent positions in three-dimensional space rather than their actual locations on a two-dimensional screen.

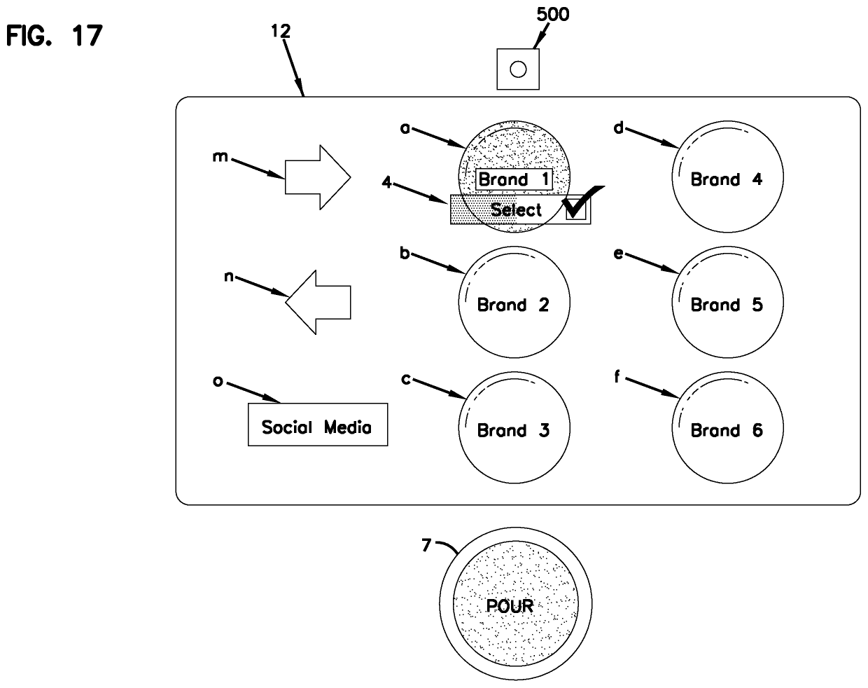

Referring to FIGS. 16-21, the eye tracking system 500 is located in association with the front of the display screen 12. In FIG. 17, when the consumer gazes at one of the brand category icons (e.g., visual entity a), that brand category icon is visually highlighted indicating an impending selection. If the consumer's gaze remains on that brand category icon for some time-out period (e.g., 0.5, 1, 2, 3, and/or 5 seconds), the persistent selection of that brand category icon is executed. If the consumer's gaze moves away from that brand category icon before the time-out period is complete, a selection does not occur.

A status indicator 4 can appear in association with the brand category icon to serve as the visual highlight and to inform the consumer of how much time remains until selection occurs. One example of a status indicator is a moving bar. When the bar has traversed its full range, the selection occurs. Other indicators (e.g., visual and/or audible) can also be used.

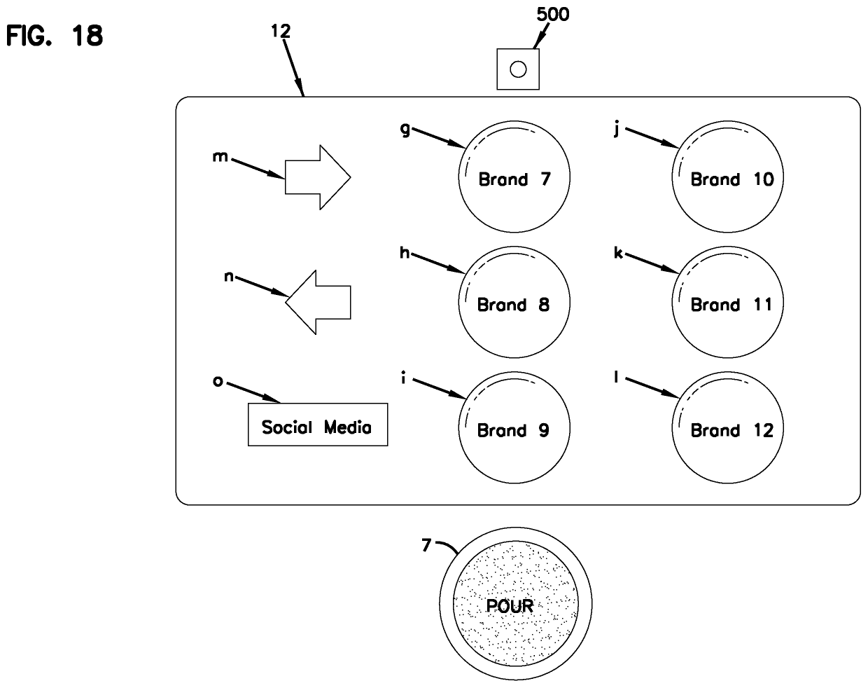

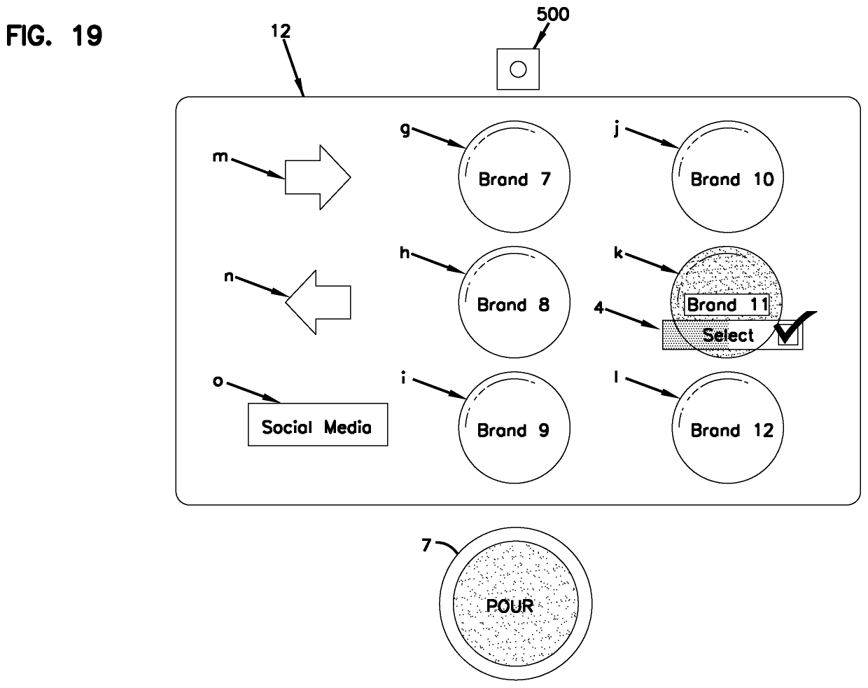

Once a brand category is selected, the graphical user interface depicted on the display screen 12 can move to another hierarchical level (see FIG. 18), where an array of brand icons g-l can be displayed. A brand is selected in a similar manner (see FIG. 19).

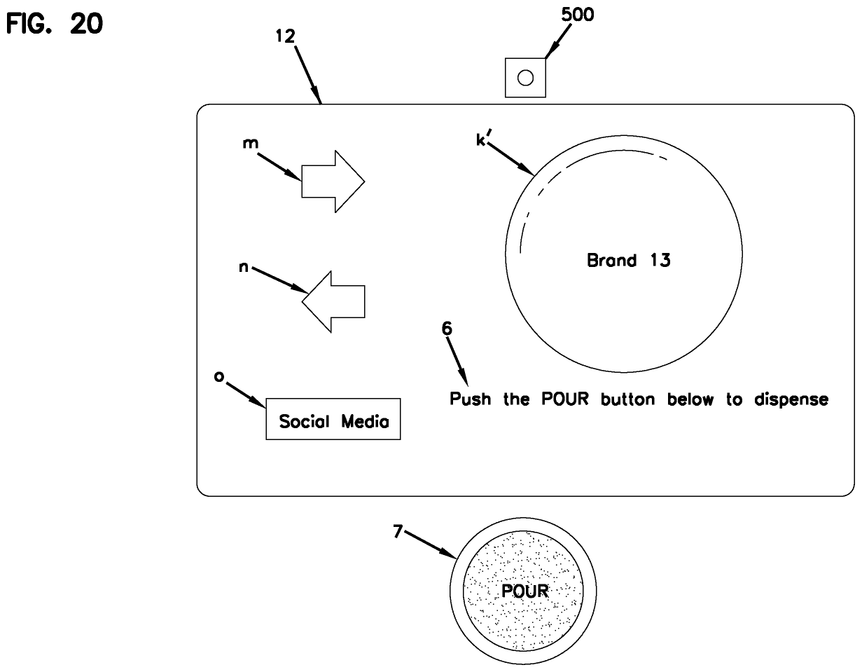

Once the brand to dispense is selected, the graphical user interface can move to another level (see FIG. 20), where an indication of the selected brand k′ is shown and the consumer is instructed by text 6 to push a hand operated push-to-pour button 7 to dispense the beverage. Once the hand operated push-to-pour button 7 is pushed and held, the consumer can direct his/her full attention to watching the fill level of the beverage in the cup. The flow of beverage can be stopped by releasing the hand operated push-to-pour button 7.

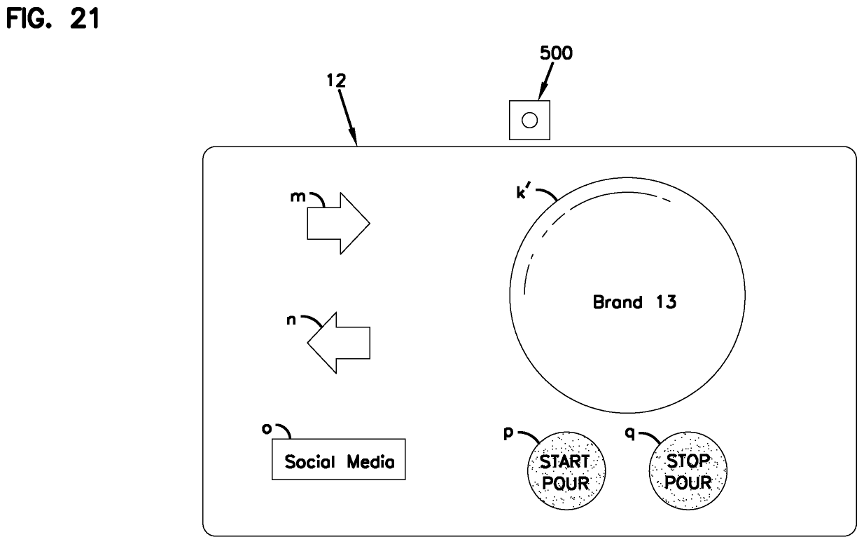

In an alternative embodiment shown in FIG. 21, the graphical user interface includes an indication of the selected brand k′, along with on-screen virtual dispense actuation buttons p and q. The consumer gazes at the “start pour” button p to begin the dispense. The consumer can then watch the fill level in the cup and then stop the dispense by gazing at the “stop pour” button q. This second embodiment does not require a hand operated button. A single virtual dispense actuation button (not shown) can also be used where the virtual button toggles back and forth between “start pour” and “stop pour”.

At the beginning of such consumer interactions, a calibration sequence may occur. In some examples, calibration is only necessary at certain intervals or after apparent problems associated with a particular consumer (e.g., the consumer requests calibration and/or the system identifies that the consumer is struggling to use the system with its current configuration). In other embodiments, the calibration occurs before every consumer interaction.

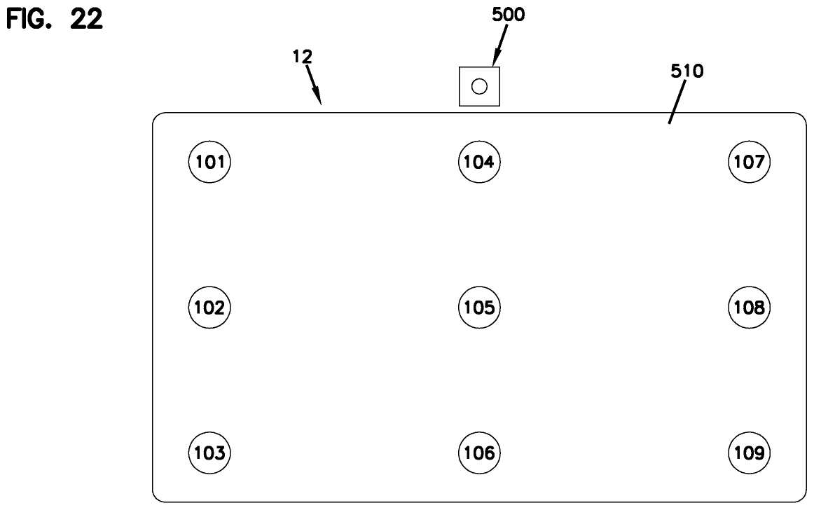

FIG. 22 shows a two-dimensional graphical user interface 510 for calibration of the eye tracking system 500. A calibration sequence can be executed where some or all of calibration targets 101-109 may be shown one at a time on the display screen 12. Calibration targets 101-109 are preferably located to substantially span the full range of the display area of the display screen 12.

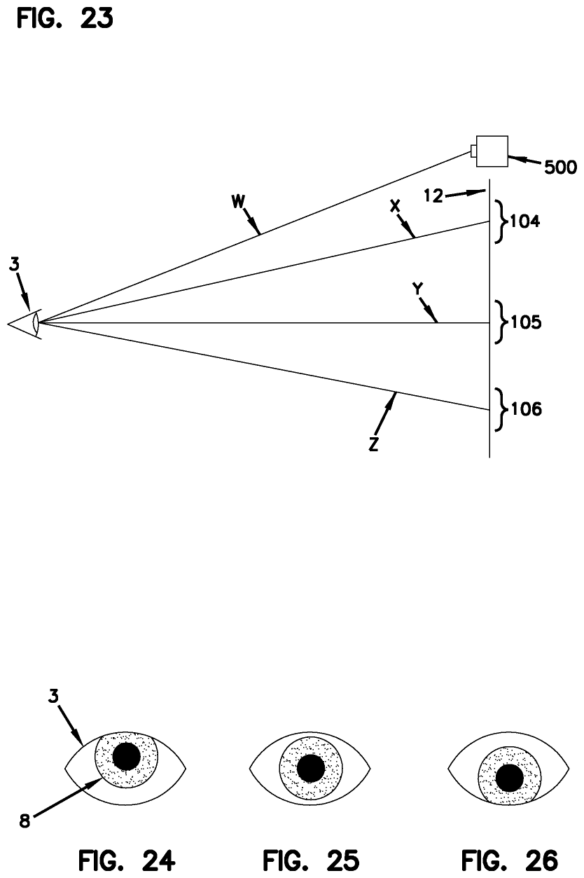

FIG. 23 shows a relationship between the consumer's gaze and a location of the calibration targets in the graphical user interface 510. Line W represents the line of sight between the eye tracking system 500 and the consumer's eye(s) 3. Line X represents the consumer's line of sight to calibration target 104. Line Y represents the consumer's line of sight to calibration target 105. Line Z represents the consumer's line of sight to calibration target 106.

While each calibration target is shown in the display, the consumer is directed to gaze at each target and the eye tracking system 500 captures an image of the consumer's eyes 3 and correlates the position of the consumer's irises 8 to the location of that calibration target. FIGS. 24, 25, and 26 show examples of the consumer's eye 3 when the consumer is gazing at calibration targets (104), (105), and (106) respectively.

After the calibration sequence, the dispensing device 10 is ready to be used. During actual use of the dispensing device 10, the eye tracking system 500 is constantly capturing images of the consumer's eyes. When the eye tracking system 500 captures an image of the consumer's eyes with the irises positioned as shown in FIG. 24, the eye tracking system 500 determines that the consumer is gazing along line X at the screen location formerly occupied by calibration target 104. When the eye tracking system 500 captures an image of the consumer's eyes 3 with the consumer's irises 8 positioned as shown in FIG. 25, the eye tracking system 500 determines that the consumer is gazing along line Y at the screen location formerly occupied by calibration target 105. If the eye tracking system 500 captures an image of the consumer's eyes 3 with the consumer's irises 8 positioned between the positions shown in FIGS. 25 and 26, the eye tracking system 500 determines that the consumer is gazing along a line proportionally intermediate to lines X and Y. When the eye tracking system 500 determines that the consumer's gaze aligns with a selectable visual entity, that selectable visual entity can be selected as shown in FIGS. 16-21.

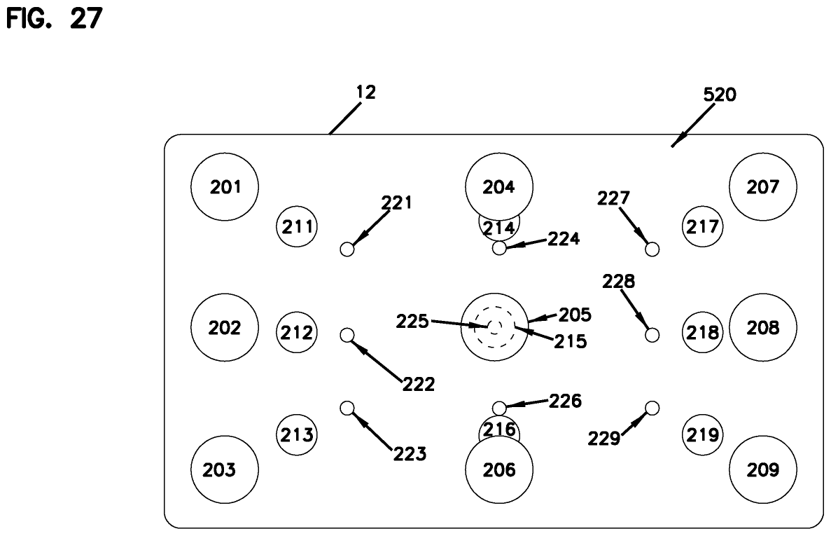

FIG. 27 schematically shows a three-dimensional graphical user interface 520 used for calibration. Calibration targets 201-209 have apparent locations in front of the plane of the display screen 12. Calibration targets 211-219 have apparent locations substantially on the front plane of the display screen 12. Calibration targets 221-229 have apparent locations behind the front plane of the display screen 12. At the beginning of the consumer interaction, a calibration sequence may be executed where some or all of calibration targets 201-209, 211-219, and 221-229 may be shown one at a time on the display screen 12. The calibration targets are preferably located to substantially span the full apparent three dimensional display volume.

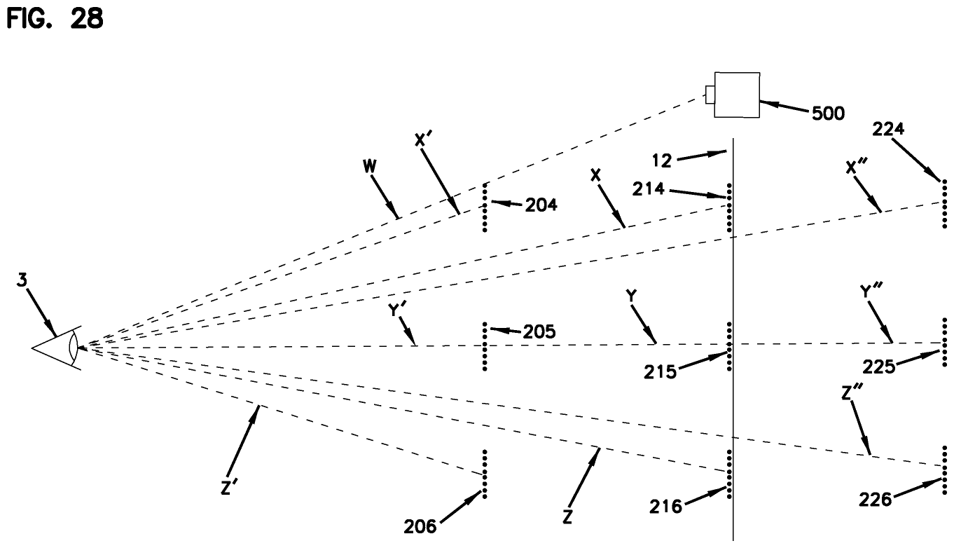

FIG. 28 shows the relationship between the consumer's gaze and the apparent location of the calibration targets in the three dimensional apparent display volume.

Line W represents the line of sight between the eye tracking system 500 and the consumer's eye 3. Line X′ represents the consumer's line of sight to the apparent location of calibration target 204. Line X represents the consumer's line of sight to the apparent location of calibration target 214. Line X″ represents the consumer's line of sight to the apparent location of calibration target 224. Line Y′ represents the consumer's line of sight to the apparent location of calibration target 205. Line Y represents the consumer's line of sight to the apparent location of calibration target 215. Line Y″ represents the consumer's line of sight to the apparent location of calibration target 225. Line Z′ represents the consumer's line of sight to the apparent location of calibration target 206. Line Z represents the consumer's line of sight to the apparent location of calibration target 216. Line Z″ represents the consumer's line of sight to the apparent location of calibration target 226.

During the calibration sequence, the positions of the consumer's irises 8 are correlated to the apparent location of each calibration target as previously described.

After the calibration sequence, in actual use, when the eye tracking system 500 determines that the consumer's gaze aligns with the apparent location of a selectable visual entity, that selectable visual entity can be selected as shown in FIGS. 16-21. In some cases, e.g., calibration targets 205, 215, and 225, the lines Y′, Y, and Y″ may be substantially co-linear and therefore difficult to distinguish. In such cases it can be desirable to locate only one visual entity near that line at any one time.

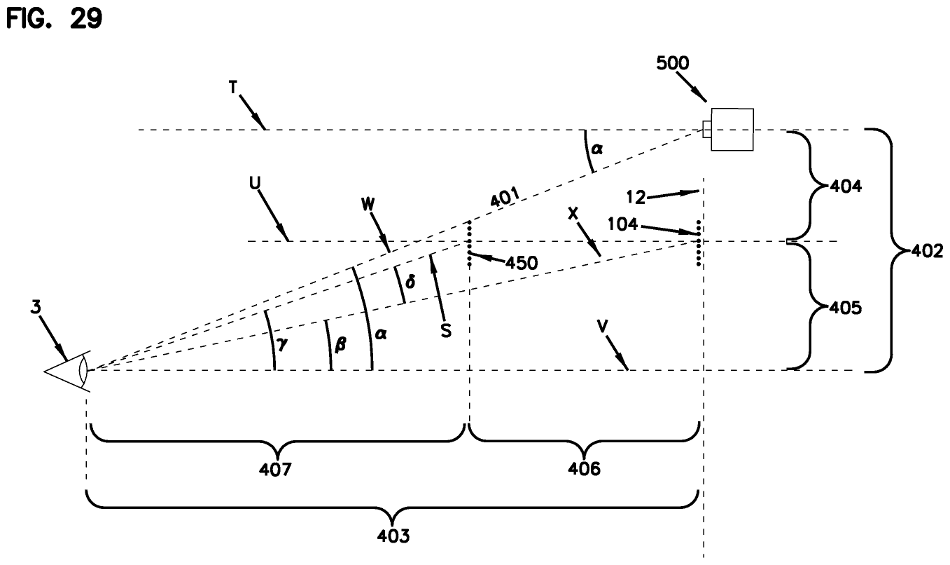

FIG. 29 shows an alternative embodiment where a two-dimensional calibration sequence is used and a correction factor is applied to account for the third dimension.

Line T is a horizontal line at the level of the eye tracking system 500. Line U is a horizontal line at the level of two dimensional calibration target 104. Visual entity 450 is aligned with line U at an apparent visual offset distance 406 towards the consumer. Distance 406 is known. Line V is a horizontal line at the level of the consumer's eyes 3. The vertical distance 404 between lines T and U is determined when programming the visual display containing calibration target 104. The angle α between lines T and W is determined by the position of the consumer's eyes 3 in the field of view of the eye tracking system 500. The angle between lines W and V is also a. The length 401 of line W is determined by, for example, a conventional range finding technology, such as by laser and/or infrared range finder techniques.

The vertical distance 402 between lines T and V equals: distance (401) sin(α).

The horizontal distance 403 between the consumer's eyes 3 and the display screen 12 equals: distance (401) cos(α).

The vertical distance 405 between lines U and V equals: distance (402)−distance (404).

The horizontal distance 407 between the consumer's eyes 3 and visual entity 450 equals: distance (403)−distance (406).

The angle β between lines V and X equals: tan−1(distance (405)/(distance (403)).

The angle γ between lines (v) and (s) equals: tan−1(distance (405)/distance (407)).

The angle δ between lines (x) and (s) equals: γ−β.

During a two dimensional calibration sequence, the eye tracking system 500 correlates the consumer's gaze along line X with calibration target 104. In order to calculate the expected line of gaze to the visual entity 450, a correction factor to compensate for the apparent visual offset 406 of visual entity 450 from the display screen 12 is calculated and applied. This correction factor might take the form of angle δ, which, when applied to line X, creates line S. The expected position of the consumer's irises 8 corresponding to line X can be determined by interpolation or extrapolation of other iris positions captured during the two dimensional calibration sequence. After the two dimensional calibration sequence is performed, the eye tracking system 500 determines that the consumer's gaze aligns with calculated line S. This correlation is used as the consumer selects a selectable visual entity as shown in FIGS. 16-21.

This is one example of how such a correction factor can be calculated and applied. Other configurations are possible.

Although the example display screen 12 is described as a three dimensional display screen, in other examples, the eye tracking system 500 can be used in conjunction with a two dimensional display screen. In those embodiments, the visual entities are displayed on the display screen in a conventional two dimensional manner. The consumer could then manipulate and/or select the visual entities by through eye movements. Other configurations are possible.

The examples provided above relate to dispensing devices for beverages. In other embodiments, the touchless input control systems described herein can be utilized in other scenarios. For example, the touchless input control system can be used in conjunction with other types of devices that dispense itemized products, such as kiosks, automated teller machines, vending machines, etc.

Further, the touchless input control systems can be used more broadly in other situations. For example, the touchless input control systems can be used in any context in which an interactive display screen is desired. Examples of these scenarios include control of non-dispensing machines, environmental systems, etc.

The example dispensing devices described herein are specialized machines programmed to perform specific tasks. Further, the devices described herein can perform more efficiently then prior devices. For example, in the dispensing context, the touchless input control systems described herein provide systems that are more robust in that the devices do not require mechanical parts that are manipulated by the consumer. This results in less wear for the devices, as well as greater efficiencies in performance and use of the devices.

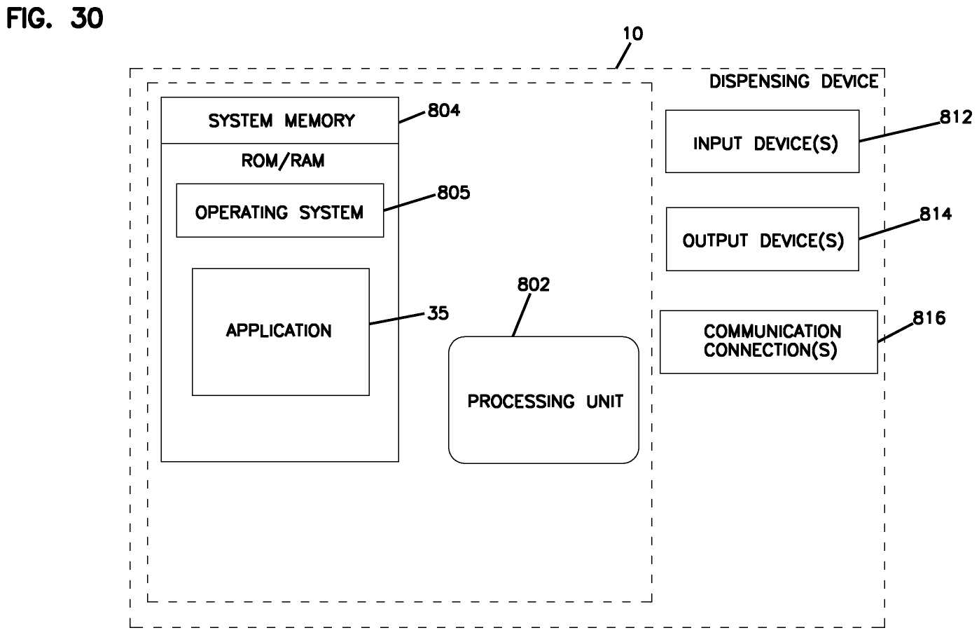

FIG. 30 is a block diagram of a device, such as dispensing device 10, with which some embodiments may be practiced. In a basic configuration, the dispensing device 10 may comprise a computing device that includes at least one processing unit 802 and a system memory 804. The system memory 804 may comprise, but is not limited to, volatile (e.g. random access memory (RAM)), non-volatile (e.g. read-only memory (ROM)), flash memory, or any combination. System memory 804 may include an operating system 805 and the application 35. The operating system 805 may control operation of the dispensing device 10.

The dispensing device 10 may have additional features or functionality. For example, the dispensing device 10 may also include additional data storage devices (not shown) that may be removable and/or non-removable such as, for example, magnetic disks, optical disks, solid state storage devices (“SSD”), flash memory or tape. The dispensing device 10 may also have input device(s) 812 such as a keyboard, a mouse, a pen, a sound input device (e.g., a microphone), a touch input device like a touch screen, control knob input device, etc. Other examples of input devices include the gesture tracking system 300 and the eye tracking system 500. Output device(s) 814 such as a display screen, speakers, a printer, etc. may also be included. An example of such an output device is the display screen 12. The aforementioned devices are examples and others may be used. Communication connection(s) 816 may also be included and utilized to connect to the Internet (or other types of networks) as well as to remote computing systems.

Some embodiments, for example, may be implemented as a computer process (method), a computing system, or as an article of manufacture, such as a computer program product or computer readable media. The computer program product may be a computer storage media readable by a computer system and encoding a computer program of instructions for executing a computer process.

Computer readable media, as used herein, may include computer storage media. Computer storage media may include volatile and nonvolatile, removable and non-removable media implemented in any method or technology for storage of information (such as computer readable instructions, data structures, program modules, or other data) in hardware. The system memory 804 is an example of computer storage media (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium that can be used to store information and that can be accessed by the dispensing device 10. Any such computer storage media may also be part of the dispensing device 10. Computer storage media does not include a carrier wave or other propagated or modulated data signal.

Computer readable media, as used herein, may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. Communication media may include wired media such as a wired network or direct-wired connection, and wireless media such as acoustic, radio frequency (RF), infrared, and other wireless media.

Some embodiments are described above with reference to block diagrams and/or operational illustrations of methods, systems, and computer program products. The operations/acts noted in the blocks may be skipped or occur out of the order as shown in any flow diagram. For example, two or more blocks shown in succession may in fact be executed substantially concurrently or the blocks may sometimes be executed in the reverse order, depending upon the functionality/acts involved.

Although various embodiments have been described in connection with various illustrative examples, many modifications may be made thereto within the scope of the claims that follow. Accordingly, it is not intended that the scope of the embodiments in any way be limited by the above description, but instead be determined entirely by reference to the claims that follow.

What is claimed is:

1. A dispensing device, comprising:
a display screen configured to present a plurality of selectable options for controlling dispensing of a plurality of products, the display screen showing a graphical user interface that displays the plurality of selectable options in three dimensions;
a touchless input control system configured to receive selection from a consumer of one selectable option from the plurality of selectable options; and
a dispensing system for dispensing one or more of the plurality of products associated with the one selectable option.

2. The dispensing device of claim 1, wherein the display screen displays the plurality of selectable options in the three dimensions to the consumer without glasses.

3. The dispensing device of claim 1, wherein the plurality of products includes a plurality of beverages.

4. The dispensing device of claim 1, wherein the touchless input control system includes a touch screen configured to operate in a hypersensitive mode.

5. The dispensing device of claim 4, wherein the hypersensitive mode causes the touch screen to sense a fingertip of the consumer at a distance from the touch screen.

6. The dispensing device of claim 5, wherein the distance is selected to approximate a three-dimensional position of one or more of the plurality of selectable options.

7. The dispensing device of claim 1, wherein the touchless input control system includes a gesture tracking system.

8. The dispensing device of claim 7, wherein the gesture tracking system is programmed to sense a position of the consumer relative to the display screen.

9. The dispensing device of claim 7, wherein the gesture tracking system is programmed to:
provide a first feedback to the consumer when the consumer enters a space associated with the display screen; and
provide a different second feedback to the consumer when the consumer selects the one selectable option.

10. The dispensing device of claim 9, wherein the first feedback is a ripple effect displayed by the display screen.

11. The dispensing device of claim 9, wherein the different second feedback occurs after a time period.

12. The dispensing device of claim 1, wherein the touchless input control system includes an eye tracking system.

13. The dispensing device of claim 12, wherein the eye tracking system is programmed to sense a position of a gaze of the consumer relative to the display screen.

14. The dispensing device of claim 12, wherein the eye tracking system is programmed to provide feedback to the consumer when a gaze of the consumer is associated with the one selectable option.

15. The dispensing device of claim 14, wherein the feedback is highlighting the one selectable option after a time period.

16. A dispensing device including a touchless control system, the dispensing device comprising:
a display screen configured to present a plurality of selectable options for controlling dispensing of a plurality of products, the display screen showing a three-dimensional graphical user interface that displays the plurality of selectable options in three dimensions to a consumer without special three-dimensional glasses;
an touchless input control system configured to receive selection from the consumer of one selectable option of the plurality of selectable options, wherein the touchless input control system includes a touch screen configured to operate in a hypersensitive mode that causes the touch screen to sense a fingertip of the consumer at a distance from the touch screen, wherein the distance is selected to approximate a three-dimensional position of one or more of the plurality of selectable options; and
a dispensing system for dispensing one or more of the plurality of products associated with the one selectable option.

17. The dispensing device of claim 16, wherein the plurality of products includes a plurality of beverages.

18. A method of controlling a beverage dispensing system, the method comprising:
displaying, upon a display screen in three dimensions, a plurality of selectable options for controlling dispensing of plurality of beverages;
allowing a consumer to select one selectable option of the plurality of selectable options without touching the display screen; and
dispensing a beverage of the plurality of beverages associated with the one selectable option.

19. The method of claim 18, further comprising sensing selection of the one selectable option a distance from the display screen.

20. The method of claim 19, further comprising selecting the distance to approximate a three-dimensional position of the one selectable option.
